(19) United States
(12) Patent Application Publication
(10) Pub. No.: US 2008/0086538 A1
(43) Pub. Date: Apr. 10, 2008

(54) ADDRESS OFFSET CONTROL CIRCUIT

(75) Inventor: Yoshitaka SUZUKI, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/769,119

(22) Filed: Jun. 27, 2007

(30) Foreign Application Priority Data
Oct. 6, 2006 (JP) 2006275562

(51) Int. Cl. G06F 15/167

(52) U.S. Cl. 709/213

(57) ABSTRACT

The present invention provides an address offset control circuit that includes a plurality of address offset addition circuits, and a plurality of selection circuits. The address offset addition circuits respectively add predetermined offset values to addresses respectively outputted from processors (e.g., CPUs) which respectively obtain access to a memory, and respectively output the results of addition thereof. In doing so, the selection circuits respectively select the results of addition by the address offset addition circuits and the addresses outputted from the CPUs and supply the same to the memory.

### BACKGROUND OF THE INVENTION

The present invention relates to an address offset control circuit for preventing that in a multiprocessor system or the like having a plurality of processors that obtain access to a shared memory, the processors (e.g., central processing units, which are hereinafter called “CPUs”) write data into the same memory address to destroy data on the memory, thereby causing a malfunction as a system.

As multiprocessor systems, there have heretofore been known those described in, for example, patent documents (Japanese Unexamined Patent Publication No. Hei 11(1999)-102348, Japanese Unexamined Patent Publication No. 2001-318906 and Japanese Unexamined Patent Publication No. 2002-245022).

FIG. 2 is a schematic configuration diagram showing a conventional multiprocessor system described in each of the patent documents 1 through 3 or the like.

The multiprocessor system includes a shared memory 1 having an address terminal A1, and a plurality of memory accessing CPUs 2-1 and 2-2 respectively having address terminals A2 and A3 that output addresses therefrom. The address terminal A1 of the memory 1 for these, and the address terminals A2 and A3 of the CPUs 2-1 and 2-2 are connected to one another via a plural(n)-bit shared address bus 3. Incidentally, only the address bus 3 is described as a system bus in FIG. 2 for the purpose of making an explanation easy.

In this type of multiprocessor system, the CPUs 2-1 and 2-2 are capable of outputting addresses and obtaining access to the same memory 1 (performing read or write on the memory 1).

However, the conventional multiprocessor system has the possibility that the plurality of CPUs 2-1 and 2-2 will write over the same address of the same memory 1 thereby to destroy data stored in one CPU 2-1 by the other CPU 2-2. Thus, the conventional multiprocessor system was accompanied by the problem that it took time to specify a malfunction in software (program), which became its cause.

### SUMMARY OF THE INVENTION

With the foregoing in view, it is therefore an object of the present invention to provide an address offset control circuit that prevents data stored in one processor from being destroyed by the other processor and specifies a malfunction in program, which becomes its cause.

According to one aspect of the present invention, for attaining the above object, there is provided an address offset control circuit suitable for use in a multiprocessor system or the like, which comprises a plurality of address offset addition circuits and a plurality of selection circuits. The address offset addition circuits correspond to circuits that respectively add predetermined offset values to addresses respectively outputted from a plurality of processors that respectively obtain access to a shared memory, and output the results of addition thereof. Further, the selection circuits correspond to circuits that respectively select the results of addition by the address offset addition circuits and the addresses outputted from the processors and supply the same to the memory.

According to the present invention, since a plurality of address offset addition circuits and a plurality of selection circuits are provided, addresses outputted from a plurality of processors can exclusively be controlled, so that no competition takes place therebetween, thus making it possible to prevent data of the other processor from being destroyed by one processor.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a schematic configuration diagram of an address offset control circuit showing a first embodiment of the present invention;

FIG. 2 is a schematic configuration diagram illustrating a conventional multiprocessor system;

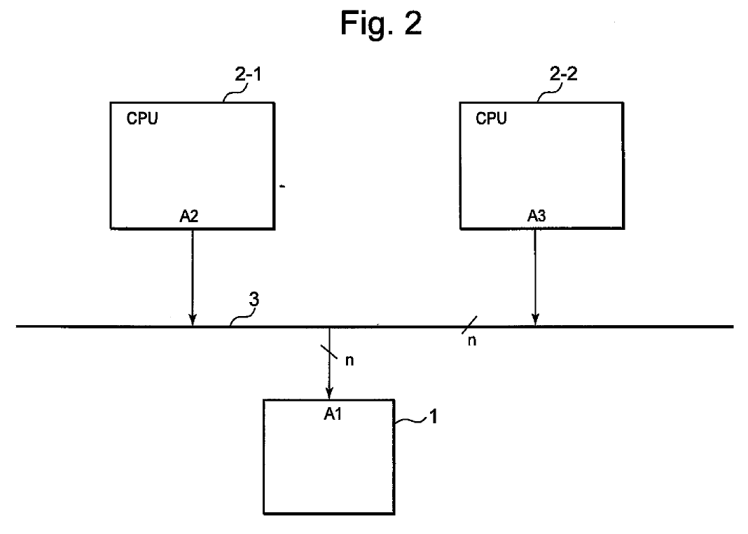

FIG. 3 is a schematic configuration diagram depicting an internal data area of a memory 10 shown in FIG. 1;

FIG. 4 is a schematic configuration diagram of an address offset control circuit showing a second embodiment of the present invention;

FIG. 5 is a schematic configuration diagram illustrating an internal data area of a memory 10 shown in FIG. 4;

FIG. 6 is a schematic configuration diagram of an address offset control circuit depicting a third embodiment of the present invention; and

FIG. 7 is a schematic configuration diagram of an address offset control circuit showing a fourth embodiment of the present invention.

### DETAILED DESCRIPTION OF THE PREFERRED EMBODIMENTS

An address offset control circuit has a plurality of address offset addition circuits and a plurality of selection circuits. The address offset addition circuits respectively add predetermined offset values to addresses respectively outputted from a plurality of processors (e.g., CPUs) that respectively obtain access to a shared memory, and output the results of addition thereof. In doing so, the selection circuits respectively select the results of addition by the address offset addition circuits and the addresses outputted from the CPUs and supply the same to the memory.

Preferred embodiments of the present invention will hereinafter be described with reference to the accompanying drawings.

### First Preferred Embodiment

### Configuration of First Embodiment

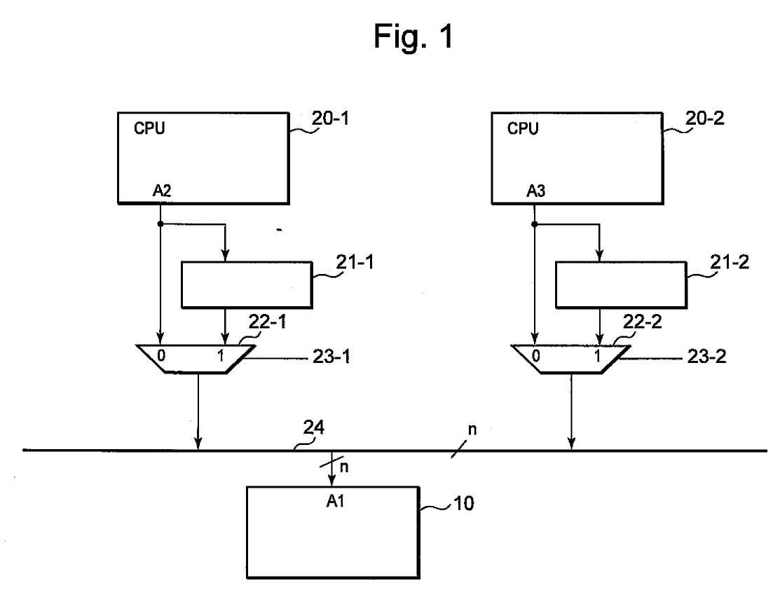

FIG. 1 is a schematic configuration diagram of an address offset control circuit suitable for use in a multiprocessor system or the like, showing a first embodiment of the present invention.

The address offset control circuit is constituted of a semiconductor integrated circuit or the like and includes a shared memory 10 provided inside or outside the semiconductor integrated circuit or the like, and a plurality of (e.g., two) processors (e.g., CPUs) 20-1 and 20-2 for respectively obtaining access to the memory 10. The memory 10 has an address-inputting address terminal A1 or the like and is constituted of a random accessible memory (hereinafter called “RAM”) or the like. The CPUs 20-1 and 20-2 have address-outputting address terminals A2 and A3 or the like. Input terminals of address offset addition circuits 21-1 and 21-2 are respectively connected to the respective address terminals A2 and A3. Logic “0” input terminals of selection circuits 22-1 and 22-2 are respectively connected to the address terminals A2 and A3.

Output terminals of the respective address offset addition circuits 21-1 and 21-2 are respectively connected to logic “1” input terminals of the selection circuits 22-1 and 22-2. Each of the selection circuits 22-1 and 22-2 is of a circuit that selects a signal inputted to the logic “0” input terminal or the logic “1” input terminal, based on a signal “0” or “1” sent from each of external terminals 23-1 and 23-2 connected to their corresponding selection terminals, and outputs the same from each of their output terminals. The output terminals of the selection circuits 22-1 and 22-2 are respectively connected to the address terminals A1 of the memory 10 via a plural(n)-bit address bus 24.

Incidentally, only the address but 24 is described as a system bus in FIG. 1 for the purpose of making an explanation easy.

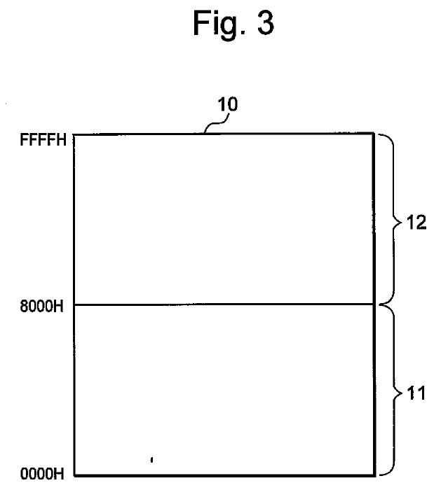

FIG. 3 is a schematic configuration diagram showing an internal data area of the memory 10 shown in FIG. 1.

The memory 10 has, for example, a usage area 11 of the CPU 20-1, which extends from an address of 0000 to an address of 7FFF, and a usage area 12 of the CPU 20-2, which extends from an address of 8000 to an address of FFFF. The CPU 20-1 and the CPU 20-2 respectively make shared access to the memory 10 (perform read or write on the memory 10) but do not share the same area.

### Operation of First Embodiment

When, for example, the external terminal 23-1 is set to “0” and the external terminal 23-2 is set to “1”, the selection circuit 22-1 selects the “0” input terminal and the selection circuit 22-2 selects the “1” input terminal. In doing so, an address outputted from the address terminal A2 of the CPU 20-1 is selected by the selection circuit 22-1 and sent to the address bus 24. An address outputted from the address terminal A3 of the CPU 20-2 is supplied to the address offset addition circuit 21-2.

The address offset addition circuit 21-2 adds an offset value 8000 to the address outputted from the address terminal A3 of the CPU 20-2 and outputs the result of its addition therefrom. The added address is selected by the selection circuit 22-2 and supplied to the address terminal A1 of the memory 10 via the address bus 24. Thus, the CPU 20-1 and the CPU 20-2 respectively obtain access to the different usage areas 11 and 12 of the same memory 10, with the result that no competition occurs between read and write.

### Advantageous Effects of First Embodiment

According to the first embodiment, since the address offset addition circuits 21-1 and 21-2 and the selection circuits 22-1 and 22-2 are provided, the addresses outputted from the CPUs 20-1 and 20-2 can be exclusively controlled, so that no competition occurs therebetween. It is thus possible to prevent corruption or destruction of data of the other CUP 20-2 (or 20-1) by one CPU 20-1 (or 20-2).

### Second Preferred Embodiment

### Configuration of Second Embodiment

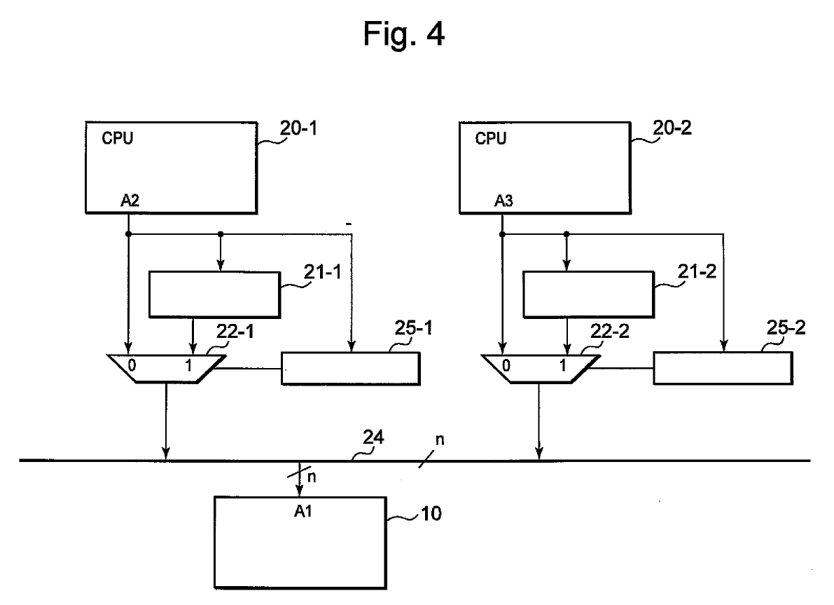

FIG. 4 is a schematic configuration diagram of an address offset control circuit suitable for use in a multiprocessor system or the like, showing a second embodiment of the present invention. Common symbols are respectively attached to elements common to those shown in FIG. 1 showing the first embodiment.

In the address offset control circuit according to the second embodiment, address discrimination circuits 25-1 and 25-2 are provided in place of the external terminals 23-1 and 23-2 employed in the first embodiment. The address discrimination circuits 25-1 and 25-2 are circuits which respectively have input terminals connected to their corresponding address terminals A2 and A3 of CPUs 20-1 and 20-2 and output terminals connected to their corresponding selection terminals of selection circuits 22-1 and 22-2 and which respectively discriminate between addresses outputted from the address terminals A2 and A3 of the CPUs 20-1 and 20-2 to thereby select “0” input terminals or “1” input terminals of the selection circuits 22-1 and 22-2 according to the results of their discrimination. Other configurations are similar to those of the first embodiment.

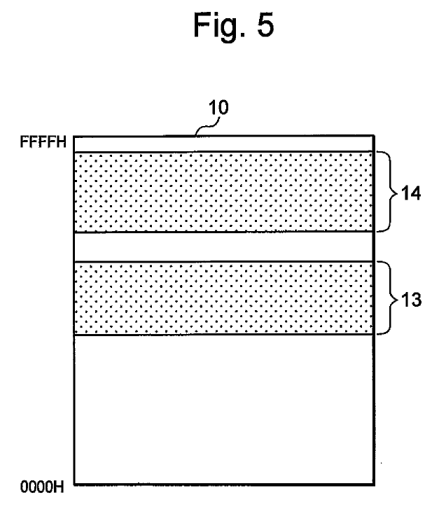

FIG. 5 is a schematic configuration diagram showing an internal data area of a memory 10 shown in FIG. 4.

The memory 10 has, for example, arbitrary usage areas 13 and 14 of the CPUs 20-1 and 20-2, which are provided between an address of 0000 and an address of FFFF. The CPUs 20-1 and 20-2 respectively make shared access to the memory 10 (perform read or write on the memory 10) but do not share the same area.

### Operation of Second Embodiment

The address discrimination circuits 25-1 and 25-2 respectively discriminate whether high-order bits of addresses outputted from the address terminals A2 and A3 of the CPUs 20-1 and 20-2 are all “0”, for example. When the high-order bits are all “0”, the address discrimination circuits 25-1 and 25-2 output “1” respectively, whereas if not so, then the address discrimination circuits 25-1 and 25-2 output “0” respectively. When the output signals of the address discrimination circuits 25-1 and 25-2 are “1”, the selection circuits 22-1 and 22-2 respectively select output signals of address offset addition circuits 21-1 and 21-2.

Therefore, when the high-order bits of the addresses that the CPUs 20-1 and 20-2 try to perform read or write thereon are all “0”, the address offset addition circuits 21-1 and 21-2 respectively add address offset values to the addresses outputted from the CPUs 20-1 and 20-2. The addresses of the usage areas 13 and 14 thereof are supplied to the memory 10. By designing the address offset addition circuits 21-1 and 22-2 in such a manner that the different address offset values are respectively added to the addresses, the CPUs 20-1 and 20-2 respectively obtain access to the usage areas 13 and 14 of the same memory 10 and hence no competition occurs between the read and write.

### Advantageous Effects of Second Embodiment

According to the second embodiment, since there are provided the address discrimination circuits 25-1 and 25-2, the output signals of the address offset addition circuits 21-1 and 21-2 can be used without using such external terminals 23-1 and 23-2 as described in the first embodiment, and the addresses outputted from the CPUs 20-1 and 20-2 can be exclusively controlled as shown in FIG. 5. Thus, no competition occurs and hence one CPU 20-1 (or 20-2) can be prevented from destroying data of the other CPU 20-2 (or 20-1).

### Third Preferred Embodiment

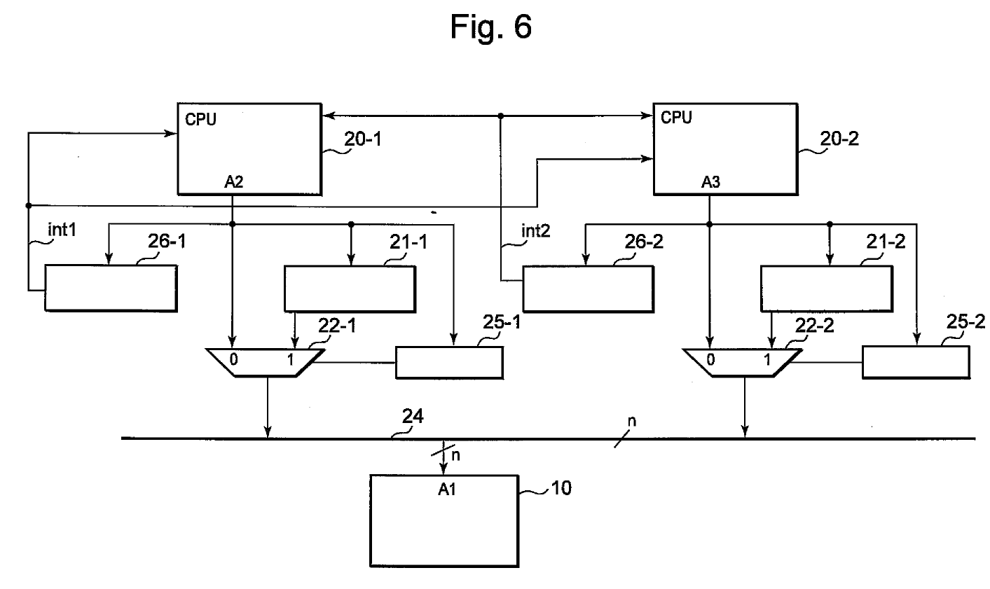

FIG. 6 is a schematic configuration diagram of an address offset control circuit suitable for use in a multiprocessor system or the like, showing a third embodiment of the present invention. Common symbols are respectively attached to elements common to those shown in FIG. 4 illustrative of the second embodiment.

In an address offset control circuit of the third embodiment, input terminals of newly-added false address detection circuits 26-1 and 26-2 are respectively connected to the address terminals A2 and A3 of the CPUs 20-1 and 20-2 of the second embodiment. The false address detection circuits 26-1 and 26-2 are of circuits which, when false addresses are outputted from the CPUs 20-1 and 20-2, detect the same and assert interrupt signals int1 and int2, and notify the false addresses to the CPUs 20-1 and 20-2. Other configurations are similar to those of the second embodiment.

### Operation of Third Embodiment

When, for example, the CPU 20-1 outputs a false address from the address terminal A2, an address offset addition circuit 21-1 outputs an address obtained by adding an address offset value to the false address to a selection circuit 22-1. When the false address is inputted, an address discrimination circuit 25-1 outputs “1” to the selection circuit 22-1. Thus, the selection circuit 22-1 selects the output signal of the address offset addition circuit 21-1 and supplies the same to an address terminal A1 of a memory 10 via an address bus 24. Since the false address detection circuit 26-1 detects the false address outputted from the CPU 20-1 simultaneously with the above, the false address detection circuit 26-1 asserts the interrupt signal int1 and notifies the result of detection to the CPUs 20-1 and 20-2.

Likewise, when the CPU 20-2 outputs the false address from the address terminal A3, the address offset addition circuit 21-2 outputs an address obtained by adding an address offset value to the false address to a selection circuit 22-2. When the false address is inputted, an address discrimination circuit 25-2 outputs “1” to the selection circuit 22-2. Thus, the selection circuit 22-2 selects the output signal of the address offset addition circuit 21-2 and supplies the same to the address terminal A1 of the memory 10 via the address bus 24. Since the false address detection circuit 26-2 detects the false address outputted from the CPU 20-2 simultaneously with the above, the false address detection circuit 26-2 asserts the interrupt signal int2 and notifies the result of its detection to the CPUs 20-1 and 20-2.

### Advantageous Effects of Third Embodiment

According to the third embodiment, since the false address detection circuits 26-1 and 26-2 are provided, the interrupt signals int1 and int2 are inputted when the CPUs 20-1 and 20-2 outputs the false addresses respectively. It is thus possible to easily debug programs respectively operated or driven at the CPUs 20-1 and 20-2.

### Fourth Preferred Embodiment

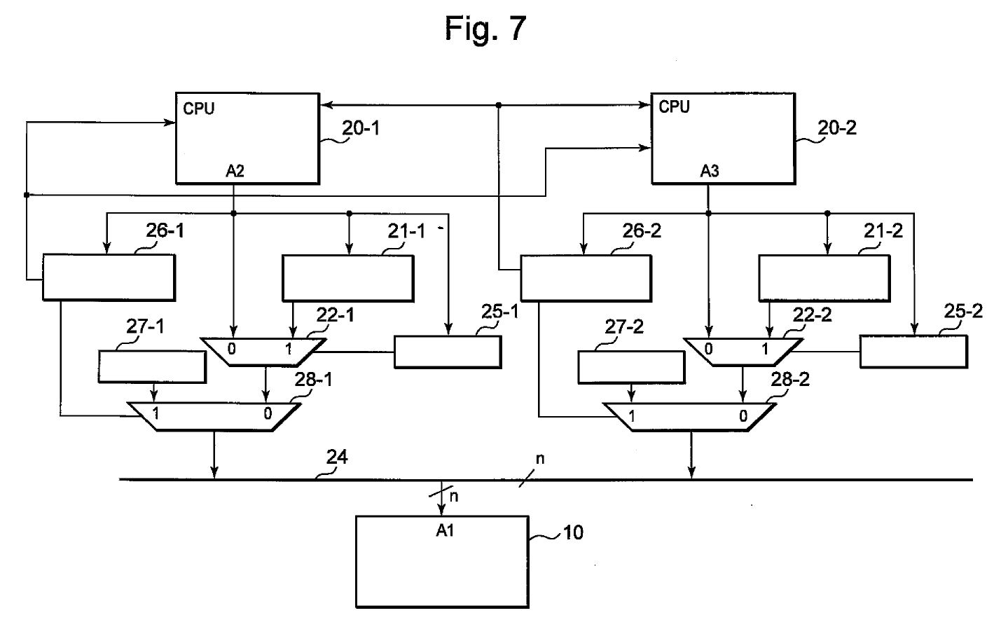

FIG. 7 is a schematic configuration diagram of an address offset control circuit suitable for use in a multiprocessor system or the like, showing a fourth embodiment of the present invention. Common symbols are respectively attached to elements common to those shown in FIG. 6 showing the third embodiment.

In the address offset control circuit of the fourth embodiment, other output terminals of the false address detection circuits 26-1 and 26-2 and the output terminals of the selection circuits 22-1 and 22-2 employed in the third embodiment are connected to an address bus 24 via newly-added address holding means (e.g., address holding registers 27-1 and 27-2 and selection circuits 28-1 and 28-2).

The address holding registers 27-1 and 27-2 are registers which hold normal addresses set thereto therein. Respective output terminals thereof are connected to their corresponding “1” input terminals of the selection circuits 28-1 and 28-2. “0” input terminals of the selection circuits 28-1 and 28-2 are respectively connected to the output terminals of the selection circuits 22-1 and 22-2. The selection circuits 28-1 and 28-2 respectively select signals inputted to the “0” input terminals or signals inputted to the “1” input terminals according to signals “0” or “1” outputted to the false address detection circuits 26-1 and 26-2 and output the same to the address bus 24. Other configurations are similar to those of the third embodiment.

### Operation of Fourth Embodiment

When, for example, a CPU 20-1 outputs a false address from an address terminal A2, the false address detection circuit 26-1 outputs a signal “1” from the other output terminal. Thus, the selection circuit 28-1 selects an address set to the address holding register 27-1 and supplies the same to an address terminal A1 of a memory 10 via the address bus 24. Likewise, when a CPU 20-2 outputs a false address from an address terminal A3, the false address detection circuit 26-2 outputs a signal “1” from the other output terminal. Thus, the selection circuit 28-2 selects an address set to the address holding register 27-2 and supplies the same to the address terminal A1 of the memory 10 via the address bus 24.

### Advantageous Effects of Fourth Embodiment

According to the fourth embodiment, since the address holding registers 27-1 and 27-2 and the selection circuits 28-1 and 28-2 are provided, the CPUs 20-1 and 20-2 respectively lead to accessing to the addresses properly set to the address holding registers 27-1 and 27-2 even when the CPUs 20-1 and 20-2 output the false addresses. Thus, the other CPU 20-2 (or 20-1) is prevented from destroying data written by one CPU 20-1 (or 20-2).

### Modifications

The present invention is not limited to the first through fourth embodiments. Various use forms and modifications can be made thereto. As examples for such use forms and modifications, the following (1) and (2) are cited for example.

(1) Although the interrupt signals int1 and int2 are outputted from the false address detection circuits 26-1 and 26-2 in FIG. 6 illustrative of the third embodiment, such a configuration as to indicate that a false address is detected at other specific register may be adopted.

(2) Although the address offset addition circuits 21-1 and 21-2 are provided in FIG. 7 showing the fourth embodiment, there is no need to provide these because accessing to the addresses set to the address holding registers 27-1 and 27-2 is done upon detection of false addresses.

What is claimed is:

1. An address offset control circuit comprising:
address offset addition circuits which respectively add predetermined offset values to addresses respectively outputted from a plurality of processors that respectively obtain access to a shared memory, and output results of addition thereof; and
a plurality of selection circuits which respectively select the results of addition by the address offset addition circuits and the addresses outputted from the processors and supply the same to the memory.

2. The address offset control circuit according to claim 1, further including a plurality of address discrimination circuits which respectively discriminate between the addresses outputted from the processors to thereby control selecting operations of the selection circuits respectively.

3. The address offset control circuit according to claim 2, further including a plurality of false address detection circuits which respectively detect false states of the addresses outputted from the processors and thereby supply interrupt signals to the processors respectively.

4. The address offset control circuit according to claim 3, further including a plurality of address holding means which respectively output normal addresses held therein when the processors output false addresses, and supplies the same to the memory.
